(19) United States
(12) Patent Application Publication
(10) Pub. No.: US 2007/0210589 A1
(43) Pub. Date: Sep. 13, 2007

(54) Cover plate and adaptor

(75) Inventor: Matthew vanGasselt, (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: TNBT Holdings Pty Limited, Mascot (AU)

(21) Appl. No.: 11/709,905

(22) Filed: Feb. 21, 2007

(30) Foreign Application Priority Data
Feb. 22, 2006 (AU) 2006900888

(51) Int. Cl. E05B 3/00

(52) U.S. Cl. 292/336.3

(57) ABSTRACT

The invention relates to a cover plate for installing a handle in a door having opposing faces, an aperture communicating from one face to the other and first and second flanges adapted to lie on the opposing faces. Each flange has an aperture, corresponding at least in part with the aperture in the faces, and first cut-outs and optionally second cut-outs. The aperture and the cut-outs enable at least one different handle to be installed. The handle may have a backset distance of 60 mm, 70 mm, 90 mm, 95 mm or 127 mm, for example. The invention also relates to an adaptor for installing a handle in a door having an aperture communicating from one face of the door to another and cut-outs at the aperture. The adaptor is capable of changing the aperture in the door from one suitable for installing one type of handle to one suitable for installation of a different type of handle. The invention also further relates to use of the cover plate with one or more adaptors.

### CROSS-REFERENCE TO RELATED APPLICATION

The present application claims the benefit under 35 USC 119 of Australian provisional No. 2006900888, lodged 22 Feb. 2006, incorporated by reference in its entirety for all purposes.

### TECHNICAL FIELD

This invention relates to a cover plate for use for installing a handle in a door, an adaptor for use for installing a handle in a door and to using an adaptor and a cover plate for replacing a handle in a door with a different handle.

### BACKGROUND OF THE INVENTION

In modern times there are many different types and kinds of doors on the market having different styles and varying dimensions. Similarly, there are many different decorative styles and forms of door handle which can be chosen to be installed in a door. It is often desired to change the handle applied to a particular door. A person may wish to install a handle with a different turning mechanism, perhaps with an improved opening and closing action. It may be that a person wishes to install a handle having a locking mechanism or to replace an existing locking mechanism that is faulty or where the keys have been lost. Locking mechanism technology is advancing all the time and it may be that it is desired to install a new handle with an improved type of locking mechanism. A person may wish to update the look of a door and so wish to change the style of the handle installed. Or a person may wish to change the shape of the handle to one that is easier to use.

Different types, forms and models of handles are available having different types, forms and models of turning mechanism. Generally, most handles have two or more parts, one of which is fed through an aperture in a door, while the other part is then screwed, or otherwise fixed, to the first part from the other side of the aperture in the door. Different handle-turning mechanisms require a particular configuration of the aperture through the door in order that the handle can be properly installed. Parts of the handle and turning mechanism need to be secured together, and to the door itself so as to be seated properly and secured in the door. It is important that the handle is secure in the door and does not work loose through use or over time. It is also important that the installed handle fits into the door in a visually pleasing manner.

A cover plate may be used to surround the area of a door into which a handle is to be installed. A cover plate may be used if the door becomes damaged, such as by being broken down to gain unauthorised access. It may be the case that when the lock was being broken or forced that the area into which the handle is installed becomes too damaged to receive a new handle. If a handle has been installed incorrectly damage may occur to the door in the area where the handle is to be installed. In these situations the cover plate can act to reinforce the area for receipt of the handle and provide means for the handle to be secured in the door, which otherwise would not be possible. The cover plate may also function to aid installation of the handle into the door and to improve the look of the door once the handle is installed.

Known cover plates have a preformed aperture of a particular size, backset distance, and configuration, suitable for installation of one particular model of handle or handle turning mechanism, only. The shape of the aperture is generally circular with cut-outs into which fit parts of the handle-turning mechanism to be installed. These parts of the handle-turning mechanism may be protrusions for screws to secure the parts of the handle together, and into a door, and/or further protrusions to aid the seating of the handle within the aperture in the door. The aperture needs to be suitable to receive the mechanism of the handle, so as to operate a latch to open and close the door. The latch extends out from the handle-turning mechanism towards the edge of the door and protrudes through an opening in the cover plate.

There are several very common layouts of these protrusions, used by the major handle manufacturers. Usually the protrusions are arranged north, south, east, and west of the circular aperture. These common layouts are available in various backset distances, including 60 mm, 70 mm and 127 mm, and less commonly 90 mm and 95 mm. The backset distance is determined by the particular handle and turning mechanism to be installed. The backset distance must be such that the handle can be installed and the latch part fit to properly enable the door to be opened and closed.

An advantage of using a cover plate is that it has an aperture of the particular size and configuration as required for installation of a handle and turning mechanism, through a door. Therefore, provided there is an aperture in the door at least as big as the aperture in the cover plate, the handle will fit snugly and can be secured firmly into the door for use. Also, use of a cover plate may be the only option, other than replacing the whole door, if the area of the door where a handle is to be installed has been seriously damaged (perhaps through criminal damage, an accident or through incorrect installation of a handle or other door furniture), the door being otherwise still serviceable.

Doors are expensive and laborious to install and it is undesirable to replace an entire door when it is only the handle, turning mechanism or locking mechanism that a person wishes to replace, for practical or aesthetic reasons. In order that a handle be replaced a person can be limited to choosing a handle or handle-turning mechanism requiring the same size aperture, cut-out layout and backset as previously installed. Clearly this is undesirable, as the person may be limited to choosing a handle from the same manufacturer as the handle previously installed.

Since the size, shape and backset of an aperture for installing a handle is particular to one type of handle and turning mechanism, it is likely that a person choosing a new handle may find that the new different handle or turning mechanism requires a different aperture configuration. The backset may be different, the aperture may be a different size and or the cut-outs for the protrusions may be in the wrong positions to allow the new handle to be installed. Therefore, the existing aperture would need to be changed to suit the new requirements, if that particular handle is to be installed.

If a smaller aperture is required than for the previously installed handle a suitable filler material will need to be used to reduce the size of the aperture to the correct size for the new handle and turning mechanism. In this case, it is likely that the finished look of the installed handle will not be aesthetically pleasing, and the handle may not be fixed securely in the door. A better approach would be to use a cover plate, which enables the larger footprint of the aperture to be covered and the new handle to be securely installed.

If a different backset is required, even if that difference is only 10 mm, then a new aperture in the door will need to be made, or the existing aperture extended or moved in order that the handle mechanism can be installed in the door.

Clearly, all these changes to a door are undesirable. Making an aperture, or adapting an existing aperture in the door is time consuming and costly and may lead to unsightly damage to the door.

A cover plate may already be installed on a door if the door has been damaged through an accident, criminal damage or through the incorrect installation of a handle. If it is desired to change the handle, handle-turning mechanism or locking mechanism a new handle will need to be chosen requiring the same size, shape and backset of the aperture as the cover plate, or the cover plate will need to be removed and replaced.

### BRIEF SUMMARY OF THE INVENTION

It is an object of the present invention to provide an improved cover plate which enables at least one different handle to be installed. It is another object of the invention to provide an adaptor which enables at least one different handle to be installed.

Accordingly, the present invention provides a cover plate for installing a handle in a door having first and second opposing faces and having an aperture communicating from one face to the other, the cover plate including first and second flanges adapted to lie on the first and second opposing faces respectively so as to cover the aperture, each flange having an aperture corresponding at least in part with the aperture in the faces, wherein the aperture in each flange includes a plurality of first cut-outs and optionally a plurality of second cut-outs, the aperture and the cut-outs being configured so as to enable at least one different handle to be installed in the door.

Preferably, the cover plate is manufactured from stainless steel or brass, but may be made of any suitable material. A finish may be applied to the cover plate to improve the appearance. Any suitable finish including polished or antiqued brass, satin bronze or oil rubbed bronze may be applied.

The cover plate may include one or more holes for receiving one or more screw(s) or other suitable fixing means to secure the cover plate to the door. The holes may be one or more pairs of opposed holes, one on each flange. These pairs of holes may be configured for receipt of screw(s), or other suitable fixing means, therethrough to secure the cover plate to the door. Preferably, there are two pairs of opposed holes lying at either end of edges of the flanges, furthest from the edge of the door.

The flanges may be substantially rectangular in shape but any suitable shape may be used.

Preferably, a spine or an edge member lies between the first and second flanges. The width of the edge member may substantially correspond to the thickness of the door to which the cover plate is to be installed. Suitable widths of the edge member include 32 mm, 35 mm, 40 mm and 45 mm but any suitable width may be used. The edge member may have an opening for receipt of a latch adapted to protrude beyond the edge member when the door is closed, or locked. The edge member may include means for securing the latching mechanism of the handle to the cover plate and or the cover plate to the door. Suitable means for attaching the cover plate to the door or the latch means to the cover plate may include use of screws and screw holes. One or more projections may be present in the opening in the edge member, having holes for receipt of screws.

The aperture in the flange may be substantially circular although the aperture may take any suitable shape. Preferably, the aperture in the flange is positioned so as to be suitable for a handle of one or more of the following backset distances to be installed: 60 mm, 70 mm, 90 mm, 95 mm or 127 mm. Any suitable backset distance may be used.

Preferably there are two first cut-outs, positioned on the circumference of the aperture, preferably at the north/south position. The first cut-outs may be any suitable shape including square or rectangular. Preferably the first cut-outs are substantially rectangular, open on one of the longer sides. The first cut-outs may be mirror images of one another. Alternatively, the first cut-outs may have a narrow opening leading to a broader part, such as an inverted triangle shape or an irregular shape.

Preferably, the first cut-outs are configured to enable protrusions of the handle to lie in the first cut-outs in one or more positions. Preferably, the protrusions can lie in the first cut-outs at more than one backset distance. Most preferably, the first cut-outs have a broad part that enables protrusions of the handle to be seated in one of two positions, one suitable for a first type or group of types of handle, and a second position suitable for a second type or group of types of handle.

There are preferably two second cut-outs, positioned on the circumference of the aperture, preferably positioned east/west. In an alternate form of the invention, the positions of the first and second cut-outs may be reversed. The second cut-outs may be smaller than the first cut-outs or may be the same size. The second cut-outs may be elongate notches. Preferably, the second cut-outs are configured so as to receive protrusions of the handle in order to secure and or seat the handle in the door.

Preferably, one or more pairs of third cut-outs is included in the aperture. If two pairs of third cut-outs are included, these are preferably positioned on the circumference of the aperture, on either side of the first cut-outs. The one or more pairs of third cut-outs may be used for securing an adaptor to the cover plate. The adaptor may be secured to the cover plate by an interference fit between one or more pairs of tab members on the adaptor and the one or more pairs of third cut-outs in the cover plate. Alternatively, any suitable means of securing the adaptor to the cover plate may be used. The third cut-outs are preferably substantially square shaped cut-outs.

In a most preferred form of the invention a pair of first cut-outs are included positioned north/south, a pair of second cut-outs are included positioned east/west and two pairs of third cut/outs are included, one pair on either side of the first cut-outs.

Preferably, the apertures in each flange are substantially identical.

The present invention also provides an adaptor for installing a handle in a door having opposing faces and having an aperture communicating from one face to the other, the adaptor having an aperture corresponding at least in part to the aperture in the face and having a plurality of cut-outs, wherein in use the adaptor is capable of changing the configuration of the aperture in the door from one suitable for installing one type or group of types of handle to one suitable for installation of a different type or group of types of handle.

Preferably, the adaptor is manufactured from stainless steel or brass, but may be made of any suitable material.

Preferably, the adaptor is substantially circular, but any suitable shape may be used.

The aperture in the adaptor may be substantially circular. The aperture may have one or more first cut-outs. The first cut-outs may be positioned north/south. The first cut-outs may be notches or may take any other suitable shape. Preferably, the first cut-outs are a shallow notch shape.

The adaptor may have one or more second cut-outs. The second cut-outs may take any suitable shape. The second cut-outs may be positioned east/west. Alternatively, the position of the first and second cut-outs may be reversed or may lie in a different configuration altogether. Preferably, the second cut-outs are an elongate notch shape.

Preferably, the first and second cut-outs are configured so as to be suitable for installation of one or more kinds of handle. The first and second cut-outs may be configured to receive protrusions of the handle in order that the handle be installed. The first and second cut-outs may assist to seat the handle in the door.

The aperture may include one or more tab members. There may be one or more pairs of tab members. The tab members may be positioned north/west and south/west or north/east and south/east. Alternatively, the tab members may be arranged in any other suitable configuration. The tab members may correspond to third cut-outs of a cover plate according to the invention.

The invention also provides a combination of a cover plate and an adaptor.

The one or more tab members of the adapter may correspond to one or more third cut-out members on the cover plate. The tab members may correspond to the third cut-outs in the cover plate in order that the adaptor may be secured to the cover plate by an interference fit. Other forms of tab members and third cut-outs in the cover plate may be used in order that the adaptor can be secured to the cover plate. For example, screws and screw holes may be used, or any other suitable fixing means.

Two pairs of third cut-outs may be present in the aperture of the cover plate configured so that the adaptor can be secured to the cover plate by a pair of tab means in a plurality of orientations. Preferably, the configuration of the two pairs of third cut-outs in the cover plate enable the adaptor to be secured to the cover plate by any of the following pairs of third cut-outs, north west and north east, north east and south east, south east and south west and south west and north west.

In a most preferred form of the invention the adaptor may be adapted to be secured to the cover plate in one position using one set of third cut-outs in the cover plate and the adaptor may be adapted to be secured to the cover plate in a second position using a different pair of the third cut-outs, to secure the adaptor to the cover plate. The two positions may have different backset distance. Use of the adaptor in one position may enable protrusions of a handle to be seated in one position. Use of the adaptor in another position may enable protrusions of the handle to be seated in a second position. Preferably, use of the adaptor decreases the size of the aperture in the door and the cover plate. The adaptor may also change the configuration of the cut-outs.

Optionally, the adaptor may include one or more adhesive means for securing the adaptor to the cover plate. The adhesive means may be double-sided tape or any other suitable means.

The handle may be any suitable handle including knob set and lever type handles. The handle may include a locking mechanism.

### BRIEF DESCRIPTION OF THE DRAWINGS

FIG. 1 is a perspective view of an embodiment of a cover plate of the present invention;

FIG. 2 is a perspective view of the cover plate of FIG. 1, from the other side;

FIG. 3 is a detailed view of the area indicated by B of FIG. 2;

FIG. 4 is a plan view of the cover plate of FIG. 2;

FIG. 5 is a perspective view of an embodiment of an adaptor of the present invention;

FIG. 6 is a detailed view of the area indicated by A of FIG. 5;

FIG. 7 is a plan view of the adaptor of FIG. 5;

FIG. 8 is an end view of the adaptor of FIG. 5;

FIG. 9 is an exploded perspective view of the cover plate of FIG. 1 installed on a door, with screws used to secure the cover plate to the door, and with two adaptors of FIG. 5;

FIG. 10 is a perspective view corresponding to FIG. 9 with the two adaptors and the screws installed;

FIG. 11 is a plan view of the cover plate of FIG. 1 and the adaptor of FIG. 5 secured in a first position with the profile of the aperture in the cover plate shown in dotted lines;

FIG. 12 is a plan view of the cover plate of FIG. 1 and the adaptor of FIG. 5 secured in a second position with the profile of the aperture in the cover plate shown in dotted lines;

FIG. 13 is a perspective view of another embodiment of the cover plate of the invention having a backset of 127 mm, with the adaptor of FIG. 5 installed and showing the position of screws used for installation in the door.

### Definitions

In the present specification the term “door” is intended to include doors for use indoors and outdoors, gates, cupboard doors, drawers and any other kind of door or closure into which a handle may be installed.

In the present specification the term “handle” is intended to mean a handle and turning mechanism which may include a locking mechanism.

For clarity, throughout the specification the term “backset” is used to describe the distance from the central point of an aperture, through which the handle will be fitted, to the edge of the door, where a latch mechanism will operate to open the door or keep it closed.

### DETAILED DESCRIPTION OF THE INVENTION

The invention will now be described in connection with a non-limiting preferred embodiment with reference to the accompanying drawings.

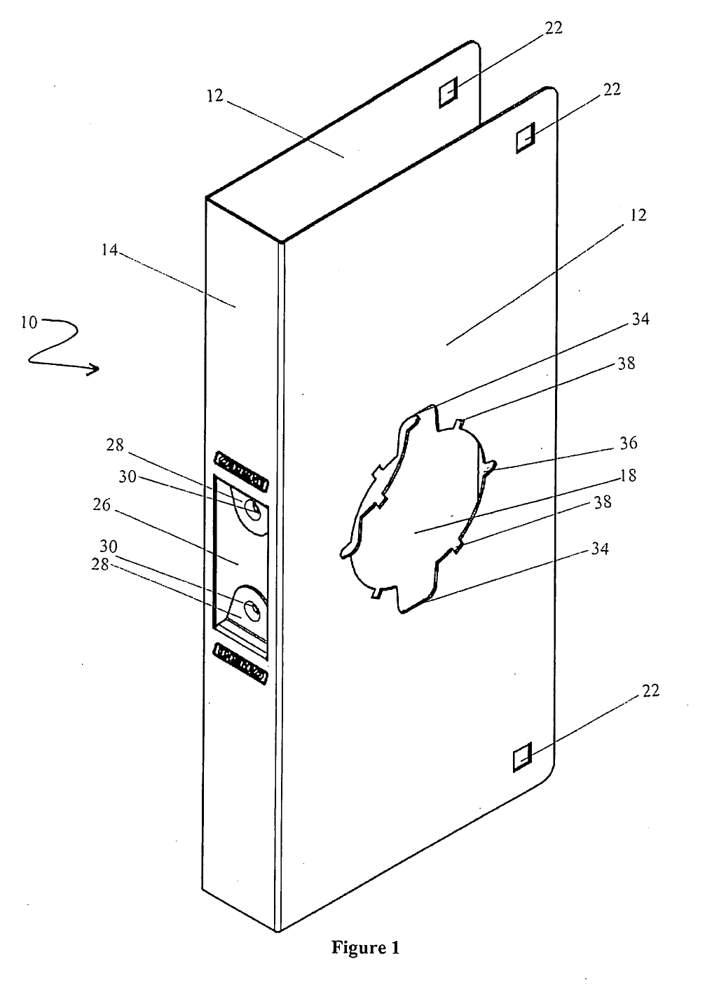

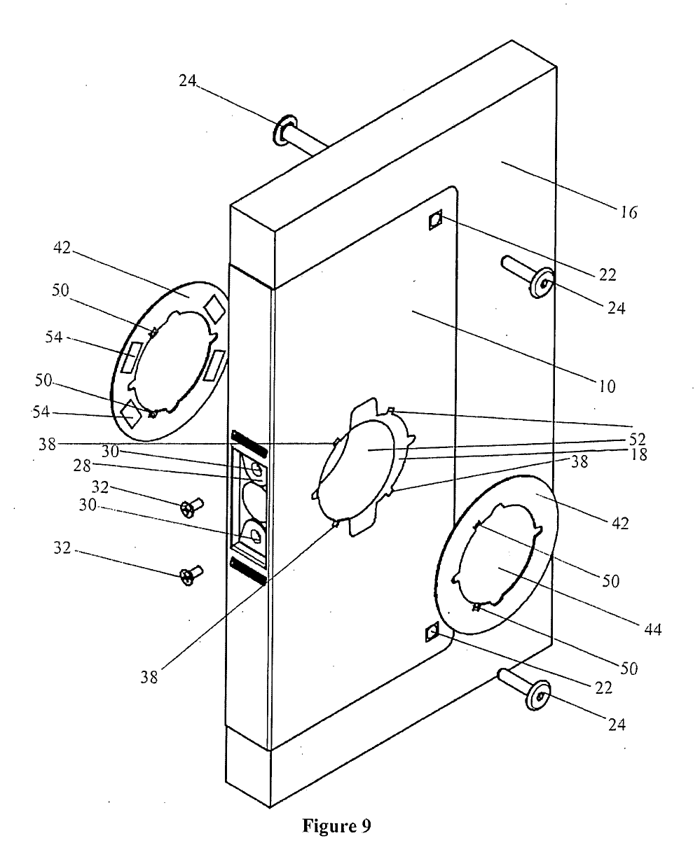

Referring to FIGS. 1 to 4, cover plate 10 has a pair of opposed flanges 12 joined, one to the other, by spine 14. Spine 14 is configured to maintain flanges 12 in a spaced apart configuration suitable for installation around the edge of door 16 (refer FIG. 9). The width of spine 14 may be any suitable width corresponding to the thickness of door 16 (refer FIG. 9) to which cover plate 10 is to be installed. Typical widths of spine 14 include, but are not limited to, 32 mm, 35 mm, 40 mm, and 45 mm. Although flanges 12 are illustrated as rectangular shapes, any suitable shape may be used. Similarly, spine 14 is illustrated as an elongate rectangular shape but any suitable shape can be used. Spine 14 need not be a solid piece and may contain numerous apertures formed of strips, or otherwise.

Apertures 18 are formed one in each flange of pair of opposed flanges 12, lying parallel to one another so that there can be communication from one aperture 18 to the other. Two pairs of opposed holes 22 lie on flanges 12 along an edge furthest from spine 14. Holes 22 are suitable for receipt of screws 24 (refer FIG. 9) for installation of cover plate 10 to door 16 (refer FIG. 9). The number and position of holes 22 can be any suitable configuration in order that cover plate 10 can be secured to door 16 (refer FIG. 9). In the illustrated embodiment, holes 22 are square as that is a particularly suitable shape for ease of manufacture and alignment of cover plate 10 but any suitable shape of holes 22 may be used.

Spine 14 has opening 26 for receipt of a latch of a handle (not shown) in order that, in a conventional manner, door 16 (refer FIG. 9) may be maintained in an open or closed position. Opening 26 can take any suitable form. Opening 26, as illustrated, has two projections 28 extending inwards, having holes 30 for screws 32 (refer FIG. 9). Screws 32 (refer FIG. 9) are used to secure latch (not shown) to cover plate 10 and may also secure cover plate 10 to door 16 (refer FIG. 9).

Apertures 18 in flanges 12 are illustrated as circular but any suitable shape may be used. Apertures 18 have first cut-outs 34, second cut-outs 36 and third cut-outs 38 (only some in FIG. 1 are labelled).

First cut-outs 34 are shown lying north and south, second cut-outs 36 east and west and third cut-outs 38 lying close to, and on either side of, first cut-outs 34. The position of first cut-outs 34 and second cut-outs 36 may be reversed. The position of the third cut-outs 38 may be any suitable configuration, see below.

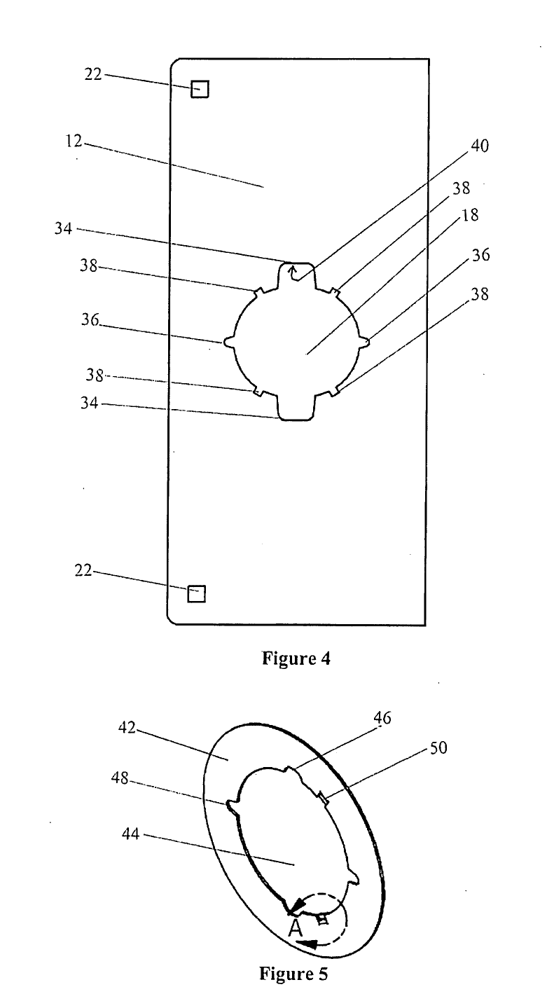

With reference to FIG. 4 in particular, first cut-outs 34 have flat base 40. The shape of first cut-outs 34 may be any suitable shape. Preferably first cut-outs 34 are broad at some point so that a plurality of kinds of handles with different handle-turning mechanisms can be installed, utilising different parts of first cut-outs 34. In a preferred embodiment of the invention the shape of first cut-out 34 is suitable to enable handles having turning mechanisms requiring different protrusion positions and/or backsets to be installed by using different parts of flat base 40 of first cut-out 34 for seating these protrusions.

Second cut-outs 36, as illustrated, are an elongate notch shape suitable for seating “pips” on the side of handle mechanisms (not shown). The particular configuration of second cut-outs 36 can be varied in accordance with the requirements of the handles (not shown) to be installed.

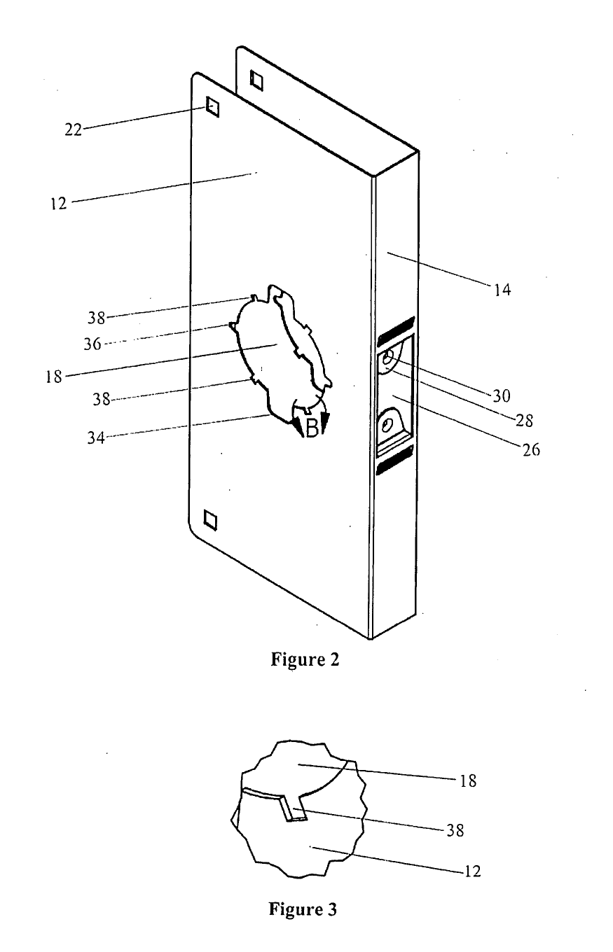

FIG. 3 illustrates a detailed view of area B of FIG. 2 showing third cut-outs 38 in detail. The particular shape of third cut-outs 38 as illustrated is substantially square but may be any suitable shape (see below).

Cover plate 10 is preferably made of stainless steel or brass but any suitable material may be used.

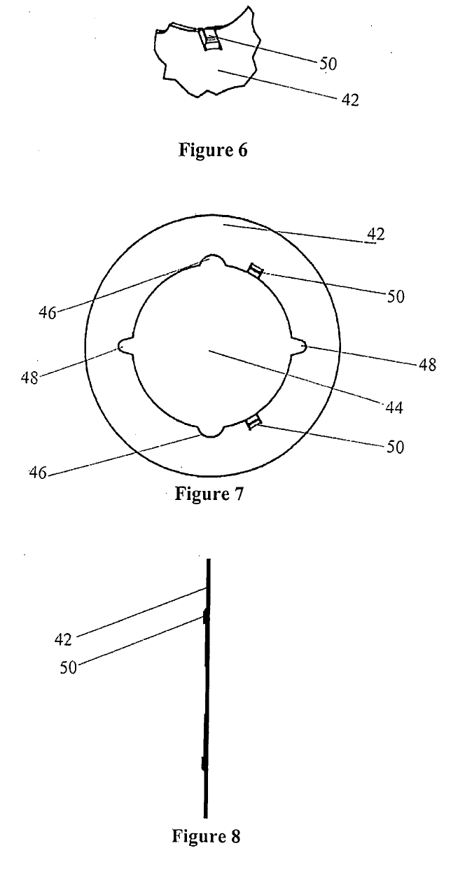

Referring to FIGS. 5 to 8, adaptor 42 is shown having aperture 44, with first notches 46 and second notches 48. The shape of notches 46 and 48 as illustrated is different, first notches 46 being broad and second notches 48 being elongate. The shape of first and second notches 46 and 48 may be any suitable shape and they may both have the same shape. First notches 46 are shown in the north/south position and second notches 48 in the east/west position. The position of the first and second notches (46, 48) may be reversed or the position may be varied. To one side of first notches 46 is a pair of tabs 50. Tabs 50 are shown in particular in FIG. 6 which is a detailed view of area A of FIG. 5. The position of tabs 50 may be any suitable position, for example to the left (as illustrated) or to the right of notches 46 or above or below notches 48. Tabs 50 are shown as square tabs but any suitable shape may be used.

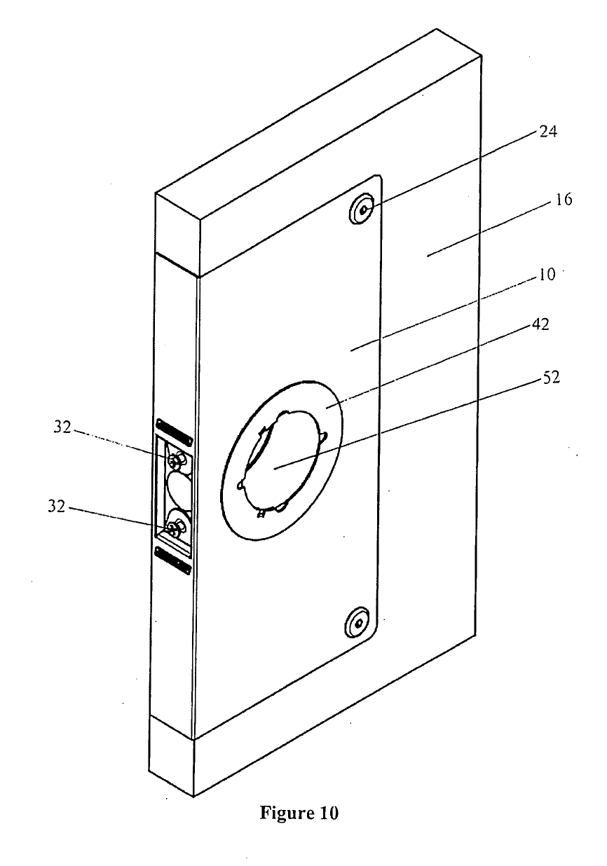

Referring to FIGS. 9 and 10, cover plate 10 is shown in position on door 16 having aperture 52. Apertures 18 in flanges 12 (refer FIG. 1) can be seen overlaying aperture 52 in door 16 allowing communication therethrough. Screws 24 are aligned with holes 22 and used to secure cover plate 10 to door 16. Other screws 32 are secured through holes 30 in projections 28 to secure spine 14 to the latch mechanism of the handle (not shown). Adaptors 42 are secured to cover plate 10 by aligning a pair of tabs 50 with third cut-outs 38 on cover plate 10 and securing using an interference fit or any other suitable means. In the illustrated embodiment, fixing tape 54 is used to aid securing of adaptor 42 to cover plate 10. Use of fixing tape 54 is optional and alternate forms of adhesion may be used or fixing tape 54 may be omitted entirely if tabs 50 are used. It can be seen that use of adaptors 42 decreases the size of apertures 18 and 52, in addition to changing the configuration of the cut-outs from the those of cover plate 10 to those of adaptors 42.

Use of cover plate 10 and adaptor 42 is particularly beneficial when a handle (not shown) is to be replaced in door 16 requiring a smaller aperture 52. Use of cover plate 10 and adaptors 42 having smaller apertures 18 and 44 (in cover plate 10 and adaptors 42 respectively), covers the existing aperture 52 in door 16 and enables sturdy, convenient and aesthetically pleasing installation of the handle (not shown).

Although the invention is described with use of cover plate 10 and adaptor 42, each component may be used individually. For example, adaptor 42 may be used to adapt aperture 52 in a door without the use of cover plate 10. Adaptor 42 could be secured to door 16 directly by use of fixing tape 54 and/or tabs 50 as described above. Similarly, cover plate 10 may be used on door 16 without adaptor 42 where apertures 18 and 52 are suitable for installation of a handle (not shown) without adaptation. It may be that cover plate 10 is used to reinforce the area of door 16 where a handle (not shown) is to be installed following damage to door 16 in that area. Use of cover plate 10 in this way enables a handle (not shown) to be securely installed rather than door 16 requiring replacement.

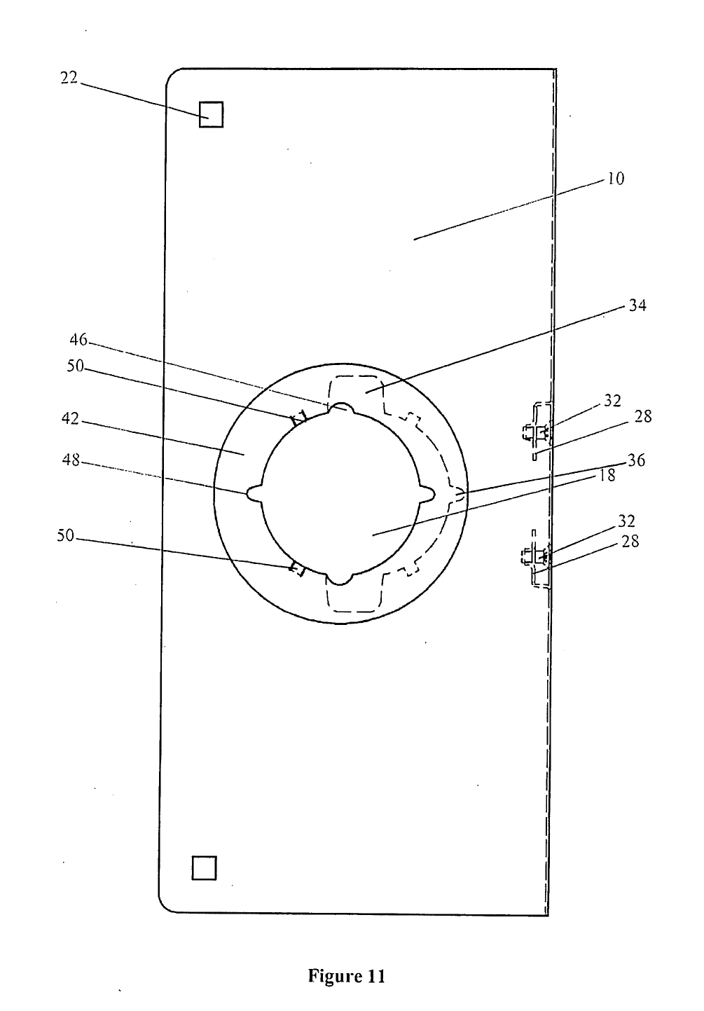

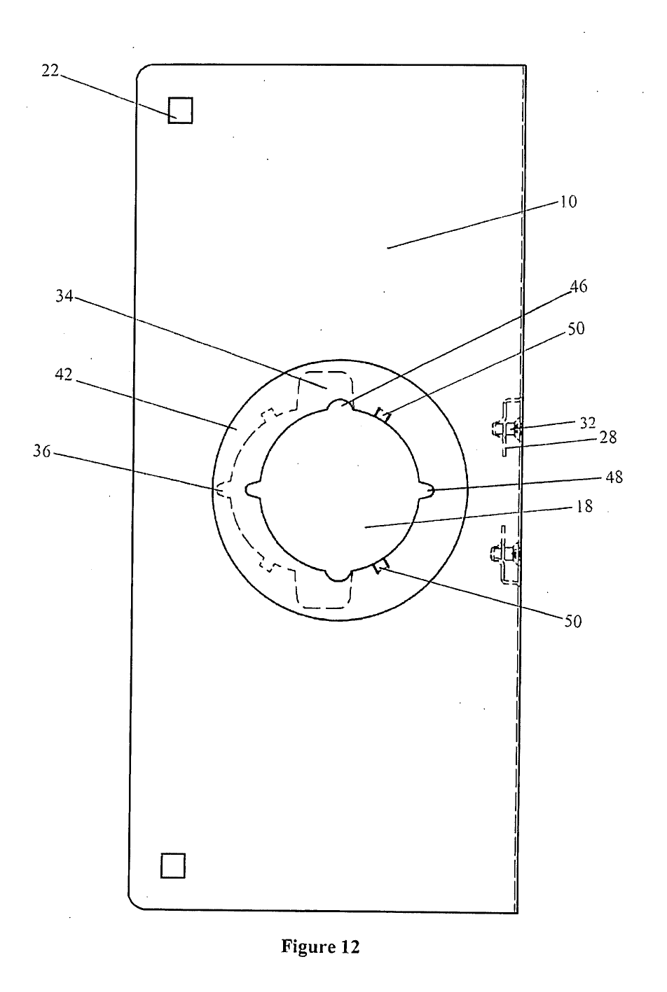

Referring to FIGS. 11 and 12, two alternative positions for installing adaptor 42 on cover plate 10 are illustrated. In FIG. 11, adaptor 42 is secured using tabs 50 in third cuts-outs 38 (hidden behind adaptor 42) on the left hand side, furthest from the edge of door 16 (refer FIG. 9). By using adaptor 42 in this way, a backset greater than the backset from the centre of aperture 18 in cover plate 10 may be achieved. Also, aperture 18 is reduced in size by utilisation of adaptor 42 and first notches 46 and second notches 48 are available for installation of a handle-turning mechanism (not shown) rather than first cut-outs 34 and second cut-outs 36, as previously. Therefore, a handle requiring a greater backset, smaller aperture, and different cut-out configuration can now be installed in door 16.

In FIG. 12, adaptor 42 has been rotated 180 degrees so that tabs 50 can be secured into third cut-outs 38 on the right hand side. By doing so, a backset less than the backset from the centre of apertures 18 in flanges 12 (refer FIG. 1) is achieved and the size of aperture 18 is reduced. Also, again the configuration of first notches 46 and second notches 48 is available for installation of a handle-turning mechanism (not shown) rather than first cut-outs 34 and second cut-outs 36. Again, a different backset and cut-out arrangement, with a smaller aperture enables a different handle with a different turning mechanism to be installed than previously. It is most advantageous to be able to change the backset distance by use of the adaptor 42 to enable installation of different kinds of handle (not shown). Previously, a fresh or extended aperture in door 16 (refer FIG. 9) would need to be made and a new cover plate 10 installed in order that the new handle be installed. Clearly, this is difficult, costly and unsatisfactory. Also, reducing the size of aperture 52 and adapting first and second (34, 36) cut-outs to first and second notches of a different configuration (46, 48) enables a large variety of different kinds and models of handles and turning mechanisms to be installed. Therefore, by using cover plate 10 and, if required, adaptor 42, a person has a huge choice of handles that can readily be installed into door 16 (refer FIG. 9) without the need to make a fresh aperture 52.

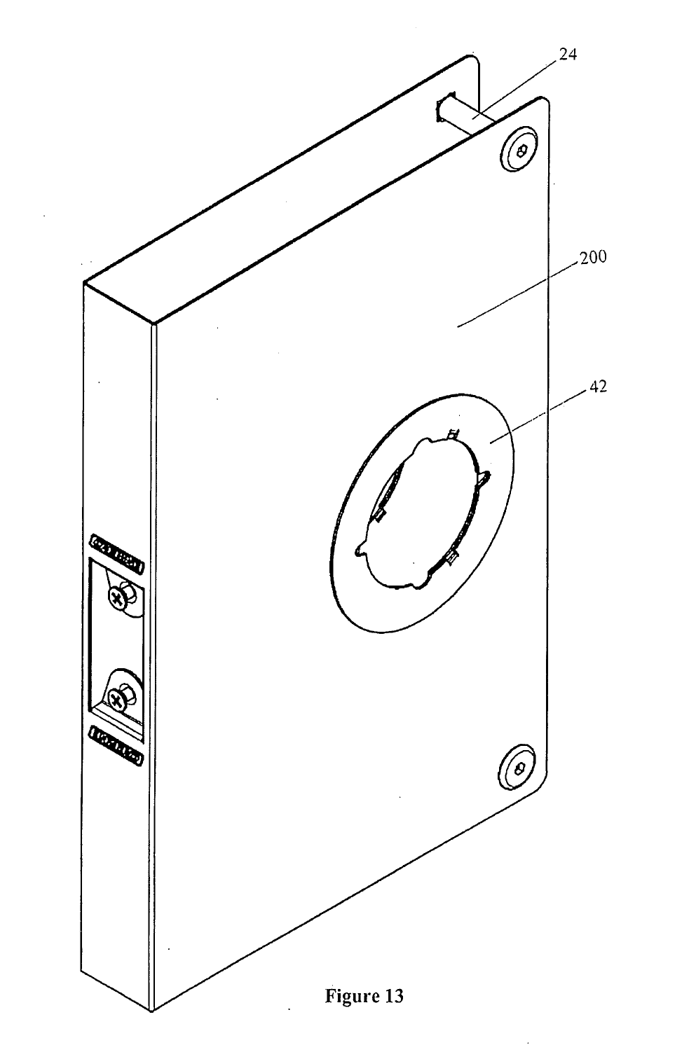

FIG. 13 shows another embodiment of the cover plate of the invention, labelled 200. Cover plate 200 is identical to cover plate 10 except it has a backset of 127 mm. Cover plate 200 is illustrated with adaptor 42 installed. FIG. 13 also illustrates how screws 24 pass through door 16 (refer FIG. 9).

It will be apparent to a person skilled in the art that changes may be made to the embodiment disclosed herein without departing from the spirit and scope of the invention in its various aspects.

What is claimed is:

1. A cover plate for installing a handle in a door having first and second opposing faces and having an aperture communicating from one face to the other, the cover plate including first and second flanges adapted to lie on the first and second opposing faces respectively so as to cover the aperture, each flange having an aperture corresponding at least in part with the aperture in the faces, wherein the aperture in each flange includes a plurality of first cut-outs and optionally a plurality of second cut-outs, the aperture and the cut-outs being configured so as to enable at least one different handle to be installed in the door.

2. The cover plate according to claim 1, wherein the cover plate is manufactured from stainless steel or brass.

3. The cover plate according to claim 1, wherein one or more hole(s) are included for receipt of one or more screw(s) to secure the cover plate to the door.

4. The cover plate according to claim 3, wherein the hole(s) are one or more pairs of opposed holes, one on each flange and there are two pairs of opposed holes lying at either end of edges of the flanges, furthest from the edge of the door.

5. The cover plate according to claim 1, wherein the flanges are substantially rectangular.

6. The cover plate according to claim 1, wherein an edge member lies between the first and second flanges.

7. The cover plate according to claim 6, wherein the width of the edge member substantially corresponds to the thickness of the door to which the cover plate is to be installed.

8. The cover plate according to claim 6, wherein the edge member has an opening for receipt of a latch adapted to protrude beyond the edge member when the door is closed or locked.

9. The cover plate according to claim 8, wherein the edge member includes means for securing the latching mechanism to the cover plate and/or the cover plate to the door.

10. The cover plate according to claim 1, wherein the apertures in the flanges are substantially circular.

11. The cover plate according to claim 1, wherein the apertures in the flanges are positioned so as to be suitable for a handle having one or more of the following backset distances to be installed: 60 mm, 70 mm, 90 mm, 95 mm or 127 mm.

12. The cover plate according to claim 1, wherein there are two first cut-outs, positioned on the circumference of the aperture.

13. The cover plate according to claim 1, wherein the first cut-outs are substantially rectangular, open on one of the longer sides.

14. The cover plate according to claim 1, wherein the first cut-outs have a narrow opening leading to a broader part.

15. The cover plate according to claim 1, wherein the first cut-outs are configured to enable protrusions of the handle to lie in the first cut-outs in one or more positions.

16. The cover plate according to claim 1, wherein the protrusion of the handle can lie in the first cut-outs at more than one backset distance.

17. The cover plate according to claim 1, wherein the first cut-outs have a broad part that enables protrusions of the handle to be seated in one of two positions, one suitable for a first type or group of types of handle, and a second position suitable for a second type or group of types of handle.

18. The cover plate according to claim 1, wherein there are two second cut-outs, positioned on the circumference of the aperture.

19. The cover plate according to claim 18, wherein the first cut-outs are positioned substantially north/south and the second cut-outs are positioned substantially east/west on the circumference of the aperture or the position of the first cut-outs and the second cut-outs are reversed.

20. The cover plate according to claim 18, wherein the second cut-outs are smaller than the first cut-outs.

21. The cover plate according to claim 18, wherein the second cut-outs are elongate notches.

22. The cover plate according to claim 18, wherein the second cut-outs are configured so as to receive protrusions of the handle in order to secure and/or seat the handle in the door.

23. The cover plate according to claim 18, wherein there are included one or more pairs of third cut-outs.

24. The cover plate according to claim 23, wherein two pairs of third cut-outs are included, positioned on the circumference of the aperture on either side of the first cut-outs.

25. The cover plate according to claim 23, wherein one or more pairs of third cut-outs are used for securing an adaptor to the cover plate.

26. The cover plate according to claim 25, wherein the adaptor is secured to the cover plate by an interference fit between one or more pairs of tab members on the adaptor and one or more pairs of third cut-outs in the cover plate.

27. The cover plate according to claim 23, wherein the third cut-outs are substantially square shaped.

28. The cover plate according to claim 1, wherein a pair of first cut-outs are included positioned substantially north/south, a pair of second cut-outs are included positioned substantially east/west and two pairs of third cut/outs are included, one pair on either side of the first cut-outs.

29. An adaptor for installing a handle in a door having opposing faces and having an aperture communicating from one face to the other, the adaptor having an aperture corresponding at least in part to the aperture in the face and having a plurality of cut-outs, wherein in use the adaptor is capable of changing the configuration of the aperture in the door from one suitable for installing one type or group of types of handle to one suitable for installation of a different type or group of types of handle.

30. The adaptor according to claim 29, wherein the adaptor is manufactured from stainless steel or brass.

31. The adaptor according to claim 29, wherein the adaptor is substantially circular.

32. The adaptor according to claim 29, wherein the aperture has one or more first cut-out(s).

33. The adaptor according to claim 32, wherein the first cut-out(s) are a shallow notch shape.

34. The adaptor according to claim 32, wherein the adaptor has one or more second cut-out(s).

35. The adaptor according to claim 34, wherein the first cut-out(s) are positioned substantially north/south and the second cut-out(s) are positioned substantially east/west or the positions of the first and second cut-outs are reversed.

36. The adaptor according to claim 34, wherein the second cut-out(s) are an elongate notch shape.

37. The adaptor according to claim 34, wherein the first and second cut-out(s) are configured to receive protrusions of more than one type of handle in order that the handle be installed, and/or to seat the handle in the door.

38. The adaptor according to claim 29, wherein there are included one or more tab member(s).

39. The adaptor according to claim 38, wherein there are one or more pairs of tab members positioned north/west and south/west or north/east and south/east.

40. The adaptor of claim 29 when used in combination with the cover plate of claim 1.

41. The combination of claim 40, wherein the adaptor has one or more tab member(s), the cover plate has one or more third cut-out(s), and the tab member(s) correspond to the cut-out(s) to secure the adaptor to the cover plate.

42. The combination of claim 41, wherein there are two pairs of third cut-outs in the cover plate, configured so that the adaptor can be secured to the cover plate by a pair of tab means of the adaptor in a plurality of orientations including any of north west and north east, north east and south east, south east and south west, and south west and north west.

43. The combination of claim 41, wherein the adaptor is secured to the cover plate by an interference fit.

44. The combination of claim 41, wherein the adaptor is adapted to be secured to the cover plate in one position using one pair of third cut-outs in the cover plate and adapted to be secured to the cover plate in a second position using a different pair of the third cut-outs.

45. The combination of claim 44, wherein use of the adaptor in one position enables protrusions of the handle to be seated in one position and use of the adaptor in another position enables protrusions of the handle to be seated in a second position.

46. The combination of claim 45, wherein the two positions have a different backset distance.

47. The combination according to claim 40, wherein use of the adaptor decreases the size of the aperture in the door and the cover plate, and or the configuration of the cut-outs in the cover plate.

48. The combination according to claim 40, wherein the adaptor includes one or more adhesive means for securing the adaptor to the cover plate.

49. A cover plate for installing a handle in a door having first and second opposing faces and having an aperture communicating from one face to the other, the cover plate including first and second substantially rectangular flanges adapted to lie on the first and second opposing faces respectively so as to cover the aperture, each flange having a substantially circular aperture corresponding at least in part with the aperture in the faces, the aperture in each flange including a pair of substantially rectangular first cut-outs lying north south configured to enable protrusions of the handle to lie in the first cut-outs in one or more positions, a pair of elongate second cut-outs lying east west to receive further protrusions of the handle, and two pairs of third cut-outs lying on either side of the first cut-outs, and the cover plate being used with two adaptors each having an aperture corresponding at least in part to the aperture in the face of the door and each adaptor having a pair of shallow notch shaped cut-outs lying north south and a pair of elongate notch shaped cut-outs lying east west the cut-outs configured to receive protrusions of the handle and a pair of tab members which correspond to the third cut-outs of the cover plate to secure the adaptors to the cover plate wherein the apertures and the cut-outs of the cover plate and the adaptor are configured to enable at least one different handle to be installed in the door.
